(19) United States
(12) Patent Application Publication
(10) Pub. No.: US 2002/0083061 A1
(43) Pub. Date: Jun. 27, 2002

(54) Method of providing tradeshow information

(76) Inventor: Larry Russell, Tiburon, CA (US)

Correspondence Address: Pillsbury Winthrop LLP, Intellectual Property Group, 50 Fremont Street, P.O. Box 7880, San Francisco, CA, 94120-7880, US

(21) Appl. No.: 10/028,941

(22) Filed: Dec. 21, 2001

Related U.S. Application Data
(60) Provisional application No. 60/257,901, filed on Dec. 21, 2000.
(60) Provisional application No. 60/257,505, filed on Dec. 21, 2000.

(51) Int. Cl. G06F 17/30

(52) U.S. Cl. 707/10

(57) ABSTRACT

A method for providing searchable electronic databases for use in tradeshows and similar events. In the preferred embodiment, tradeshow information is collected via the Internet and electronically compiled into a database in a format compatible with a searchable reader software. The database is electronically stored on a CD, a computer hard drive, a personal digital assistant (PDA) compatible database, uploaded on a web page, or accessed on a wireless network located at the tradeshow. A user may obtain a CD, a PDA download, or an access password for the web page, and may access the database using a personal computer or a computer system provided at the tradeshow.

### CROSS-REFERENCE TO RELATED APPLICATIONS

This application claims the benefit of U.S. Provisional Application No. 60/257,901 filed Dec. 21, 2000, the contents of which are incorporated herein by reference.

### FIELD OF THE INVENTION

This invention relates generally to electronic information storage. Specifically, this invention relates to methods for creating searchable electronic databases for use in tradeshows and conventions.

### BACKGROUND OF THE INVENTION

Every year, thousands of tradeshows, expositions, conventions and conferences are held for various purposes, ranging from marketing and selling new products and services to providing educational seminars and workshops. Generally, between 20 to more than 5000 vendors or exhibitors can be found at a tradeshow or similar event, each exhibitor occupying at least one booth on the show floor. Convention centers such as the Los Angeles Convention Center provide more than 850,000 square feet of exhibition space. As such, it can be very difficult for an attendee of a large tradeshow to find a particular vendor or exhibitor without assistance.

Several solutions have been implemented to solve this problem. For example, site maps and alphabetical listings of the vendors or exhibits are often provided at large tradeshows or conventions to help an attendee locate desired vendors or exhibits. In addition, vendors and exhibits are sometimes arranged by category on the listing, and brief descriptions of the exhibits or vendors' businesses are sometimes provided as well.

Unfortunately, these “solutions” do not provide sufficient guidance for tradeshow attendees. For example, an attendee with a site map and a 30 page alphabetical listing of the vendors at a large tradeshow would have a difficult time, at best, trying to find a vendor selling a particular product, unless the attendee already knew the name of the vendor. In addition, site maps and listings are often out of date and incomplete, making things even more difficult for the attendees. Similarly, categorized listings and summaries of the exhibits also do not help much if the listings and summaries take more than a few pages. It is also customary in the United States for locations in the tradeshow to be determined by last year's attendance and the size of the exhibit, which results in the listings and summaries being arranged in a helter-skelter manner where, for example, pumps are listed next to textbooks depending upon the priority each of the vendors gained from their attendance and the size of the space that they rented previously. It would thus take considerable time for a tradeshow attendee to read through the categories or summaries to find her desired exhibitors and their locations. Furthermore, non-attendees interested in receiving vendor information from the tradeshow are not able to do so under current distribution practices.

Therefore, there exists a need for an efficient way to generate desired information for an attendee of a tradeshow or similar event so that the attendee may optimize his or her time at the event. Moreover, it would be advantageous to have a method to distribute tradeshow information to interested parties who are unable to attend the tradeshow.

### SUMMARY OF THE INVENTION

The present invention discloses methods for providing searchable electronic databases for use in conferences (e.g., tradeshows, conventions, expositions, and similar events). In the preferred embodiment, tradeshow information is collected prior to the meeting and electronically compiled into a database in a format compatible with a searchable reader software. The vendors would be allowed and encouraged to access a secure web page or wireless network, which would allow them to upload specified amounts of information including a web page address and information about their products for a specified cost. The database is electronically stored on a CD, a computer hard drive, a personal digital assistant (PDA) compatible database, or uploaded on a web page. A user may obtain a CD, a PDA download, or an access password for the web page, and may access the database using a personal computer or a computer system provided at the tradeshow.

The present invention allows a tradeshow attendee to efficiently search for desired information at the tradeshow. In addition, interested parties may readily obtain desired information without attending the tradeshow.

### DETAILED DESCRIPTION OF THE INVENTION

The present invention relates to methods for collecting and storing information relating to a tradeshow or similar event in a searchable electronic database. In the preferred embodiment of the present invention, desired information regarding a tradeshow, such as a vendor's products, web site address, catalogue information, or its location at the show, is collected prior to the tradeshow, preferably by uploading to a proprietary web page. Information can also be collected during the show. The exhibitors or vendors may submit their information for a flat fee or on a unit cost per kilobyte basis. This cost may also be bundled with any other tradeshow-related fees. The collected information is then electronically compiled into a database, preferably on CD-ROM or uploaded on a web page, in a format compatible with at least one searchable reader software. The reader software can be any software program that is capable of performing a word search on the database, for example a spreadsheet program such as Microsoft Excel, a document publishing program such as Adobe Acrobat Reader, a word-processing program such as Microsoft Word, or a PDA program. Preferably, the reader software has the capability to perform Boolean searches. That is, the database entries are preferably created with predetermined search fields or key words such as “vendor name” or “vendor products” so that a user may use the reader software to search the entries by fields in addition to text search.

In accordance with the preferred embodiment of the present invention, the database is compiled on CD-ROM, and copies of the completed database CDs are distributed to tradeshow attendees at the beginning of and throughout the tradeshow. Copies of the database may also be distributed at the end of or after the tradeshow. The attendees may then use their own portable computers to access the data. In addition, dedicated computer systems may be provided at the tradeshow for users to perform a search on the database and obtain a copy of the search result. Preferably, the database is compiled as a text file or in a format that is compatible with a common word processing computer program, such as Microsoft Word or Excel. Alternatively, the database CD may contain an executable reader program integrated or linked to the database, which program may be run directly from the CD or downloaded onto a hard drive, and the execution of the reader program automatically opens the default database file or vice versa. Such an integrated or linked reader program may be a simple macro program designed to provide a well-defined searchable engine within a common end user software such as Microsoft Word or Excel. Of course, the database CD and the searchable reader program may be distributed separately.

In another embodiment, at least one computer system comprising a computer, a monitor and a printer is provided in at least one kiosk or booth at the tradeshow. The completed database and searchable reader software are preferably electronically uploaded on the hard drive of the computer. A user may perform a search for any desired information on the computer provided, and may obtain a printout of the information using the printer provided. Preferably, the computer system is password secured, and a user may purchase a password at the tradeshow.

In accordance with yet another embodiment, the compiled database is uploaded on a web page, which is preferably password protected. A user may purchase or obtain a password online or at the corresponding tradeshow or similar event. In one implementation, a dedicated computer system similar to the ones described above or a wireless network is provided at the tradeshow. The user may use the computer system or wireless network to access the web page, perform a search for any desired information online, and obtain a hard copy of the search results at the tradeshow. In addition, users interested in the information, but are unable to attend the tradeshow, may access the web page from a personal computer at home.

In yet another preferred embodiment, the database is compiled in a format compatible with a PDA. The database may be compiled on a PDA compatible platform and stored on a PDA downloadable station. The database may be downloaded at the tradeshow to a user's individual PDA or accessed via a wireless network at the convention center. Alternatively, the database may be compiled on a PDA card, which can be directly plugged into a PDA for access. As a third alternative, the database may be compiled and stored on a web page, and the database may then be downloaded to a PDA from the web page. Again, access to the database may be purchased for a flat fee or on a per kilobyte basis.

The various information providers (i.e., tradeshow vendors) can provide hyperlinks to their web pages or substantial information about their product or business in the database.

Although the invention herein has been described with reference to particular embodiments, it is to be understood that the embodiments are merely illustrative of the principles and application of the present invention. It is therefore to be understood that various modifications may be made to the above mentioned embodiments and that other arrangements may be devised without departing from the spirit and scope of the present invention.

I claim:

1. A method of providing information of a conference, comprising the steps of:
collecting the information;
compiling the collected information into an electronic database; and
distributing the database in an electronic medium.

2. The method of claim 1, wherein the conference is a tradeshow, the database is a searchable database viewable via a computer program, and the electronic medium is a Compact Disk.

3. The method of claim 2, wherein the step of collecting the information comprises uploading the information onto a web site

4. The method of claim 2, wherein the step of collecting the information comprises uploading the information onto a wireless network.

5. The method of claim 3, wherein the computer program is integrated with the database.

6. The method of claim 3, further comprising the steps of:
providing a computer at the tradeshow; and
viewing the information in the database on the computer.

7. The method of claim 6, wherein the information comprises a vendor's product information, web site address, catalogue information, and the vendor's location at the tradeshow.

8. The method of claim 7, wherein the information is collected prior to the tradeshow and the database is distributed in a time frame selected from the group consisting of prior to the tradeshow, during the tradeshow, and after the tradeshow.

9. The method of claim 1, wherein the conference is a tradeshow, the database is a searchable database viewable via a computer program, and the electronic medium is a PDA card.

10. The method of claim 9, further comprising viewing the information on a PDA.

11. The method of claim 10, wherein the information is collected prior to the tradeshow and the database is distributed in a time frame selected from the group consisting of prior to the tradeshow, during the tradeshow, and after the tradeshow.

12. A method of providing information of a conference, comprising the steps of:
collecting the information;
compiling the collected information into an electronic database;
storing the database in a computer at the conference; and
viewing the information on the computer.

13. The method of claim 12, wherein the step of collecting the information comprises uploading the information onto a web site.

14. The method of claim 13, wherein the conference is a tradeshow, the database is a searchable database viewable via a computer program, and the computer is located in a dedicated kiosk or booth at the tradeshow.

15. The method of claim 14, wherein the information is collected prior to the tradeshow and the database is distributed in a time frame selected from the group consisting of prior to the tradeshow, during the tradeshow, and after the tradeshow.

16. The method of claim 12, wherein the computer is a PDA.

17. The method of claim 12, wherein the computer is a wireless network.

18. A method of providing information of a conference, comprising the steps of:
collecting the information;
electronically compiling the collected information into a downloadable database; and
downloading the database onto an electronic medium for viewing.

19. The method of claim 18, wherein the step of collecting the information comprises uploading the information onto a web site.

20. The method of claim 19, wherein the electronic medium is selected from the Group consisting of personal computers, notebook computers, personal digital assistants, palmtop computers, and wireless networks.

21. The method of claim 20, wherein the conference is a tradeshow, the database is a searchable database viewable via a computer program and accessible via the Internet.

22. The method of claim 21, wherein the electronic medium is located at the tradeshow.
